(19) United States
(12) Patent Application Publication
(10) Pub. No.: US 2008/0010849 A1
(43) Pub. Date: Jan. 17, 2008

(54) Tape Measure With Two Winding Handles

(76) Inventor: Barry Howard Lee, Rayleigh Essex (GB)

Correspondence Address: BUCHANAN, INGERSOLL & ROONEY PC, POST OFFICE BOX 1404, ALEXANDRIA, VA, 22313-1404, US

(21) Appl. No.: 11/792,489

(22) PCT Filed: Dec. 8, 2005
(86) PCT No.: PCT/GB05/04750

§ 371 Date: Aug. 13, 2007

(30) Foreign Application Priority Data
Dec. 9, 2004 (GB) 042007.0

(51) Int. Cl. G01B 3/10

(52) U.S. Cl. 33/767; 33/761

(57) ABSTRACT

A tape measure has a rotatably mounted winding drum, a measuring tape attached the drum so as to be coilable thereon, and two winding handles acting respectively on each side of the drum. The winding handles are for coiling the tape onto the drum, and one or both of them may be retractable.

### FIELD OF THE INVENTION

The present invention relates to tape measures of a type requiring a winding handle.

### BACKGROUND TO THE INVENTION

Tape measures for distances of 10 metres or greater (so-called ‘long tapes’) tend to differ from those for shorter distances in that the measure blade is not sprung so that the blade returns to a spooled condition, but instead have a winding handle to spool the blade. Winding return handles can also be provided on tapes for a shorter distance.

One conventional form of ‘long tape’ measure has a case with first and second circular side walls spaced apart from each other with their peripheries connected by an edge wall, so as to define a generally disc shaped enclosure. A winding drum or spool is rotatably mounted between the side walls, the axis of the drum passing through the centre of both side walls. One side face of the drum is exposed at a central aperture in the first side wall. A winding handle is attached to the exposed part of the side of the winding drum. The other side face of the drum may be exposed in a similar fashion on the second side wall. The drum may be a single moulding trapped within the case, or may be formed from two halves which are inserted through apertures in the first and second side walls.

The measuring tape is attached at one end to the drum so that it can be coiled around the drum within the casing. It can be drawn out from the casing through a slot in the edge wall of the casing. To unwind the tape, the required length of tape is simply pulled out through the slot. To rewind the tape, the casing is gripped and the winding handle turned in the appropriate direction.

Another conventional form of ‘long tape’ measure does not have an enclosing case, but rather a frame on which the winding drum or spool is mounted. As in the above form of measure, a winding handle is attached to the winding drum to allow the tape to return to its spooled condition. Sometimes, the winding drum is mounted to the frame by means of a centre moulding. In this instance, the winding handle is attached to the centre moulding.

Many ‘long tapes’ are used by professionals, such as surveyors, estates agents and builders, and are often shared by a number of people. The present inventors have realised that the sharing a single measure can cause difficulties when different users wish to wind the tape back onto the spool in different manners. Long tapes tend to be designed to be held in the user's left hand, such that the winding handle is operated by the user's right hand. However, some users prefer to hold the tape in their right hand and operate the winding handle with their left hand. This is difficult as, with conventional tapes, the measuring blade is then upside down as it enters the casing, causing it to twist. Some tape measures solve this problem by having a winding handle that can be mounted on either side of the measure, but this is not convenient for a measure which is shared as the winding handle would be continually changed from one side to the other.

### SUMMARY OF THE INVENTION

The present inventors have solved this problem by providing a tape measure with a winding handle on both sides.

According, the present invention provides a tape measure having a rotatably mounted winding drum or reel, a measuring tape attached to the drum so as to be coilable thereon, and a winding handle acting on each side of the drum.

Both winding handles are preferably retractable, to avoid impact whilst the tape is being extended, and such that when used for winding the tape back, only one handle need be extended.

### BRIEF DESCRIPTION OF THE DRAWINGS

An embodiment of the present invention will now be described by way of example only with reference to the accompanying drawings, in which:

FIG. 1 is a plan view of a tape measure viewed from a first side, shown with the first winding handle retracted;

FIG. 2 is a plan view of the tape measure viewed from the first side, shown with the first winding handle extended;

FIG. 3 is a plan view of the tape measure viewed from a second side, shown with the second winding handle retracted;

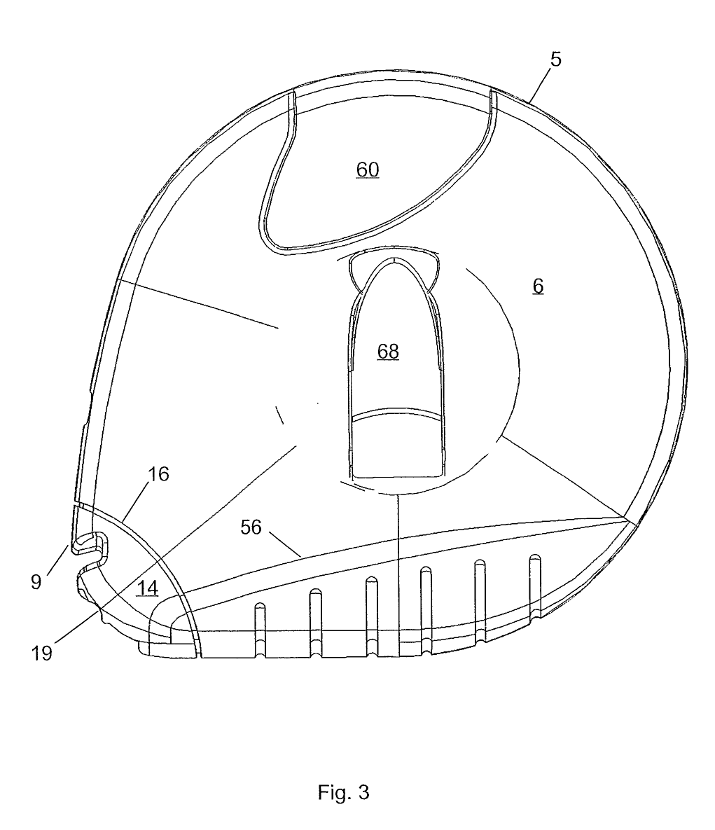

FIG. 4 is a plan view of the tape measure viewed from the second side, shown with the second winding handle extended;

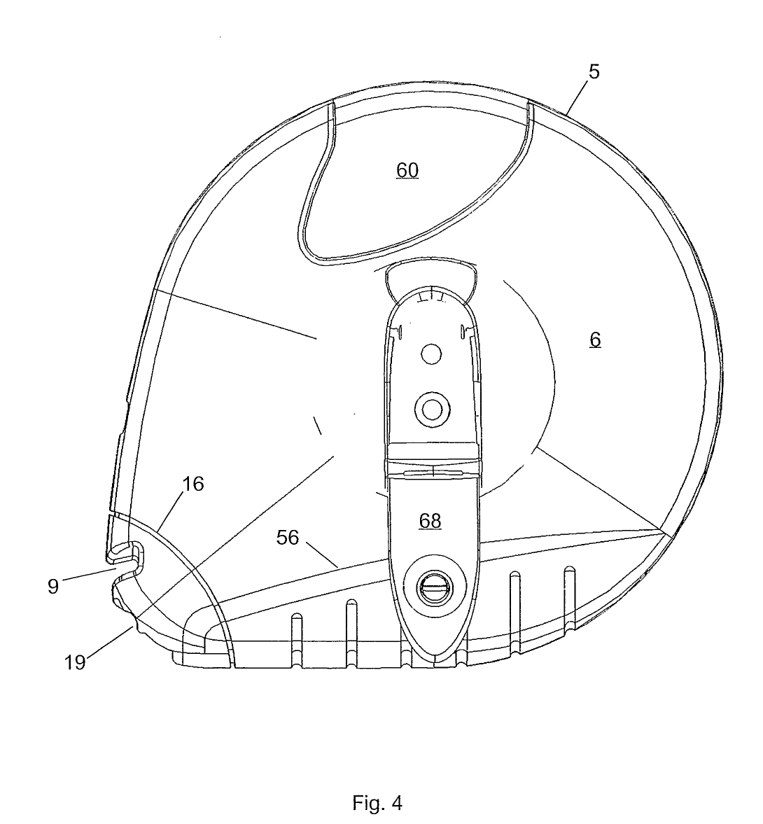

FIG. 5 is a plan view of an edge of the tape measure, shown with the first and second winding handles retracted;

FIG. 6 is a plan view of an edge of the tape measure, shown with the first winding handle extended and the second winding handle retracted;

FIG. 7 is a plan view of an edge of the tape measure, shown with the first and second winding handles extended; and

FIG. 8 is a cross-sectional view of a winding drum contained in the tape measure.

### DETAILED DESCRIPTION OF THE INVENTION

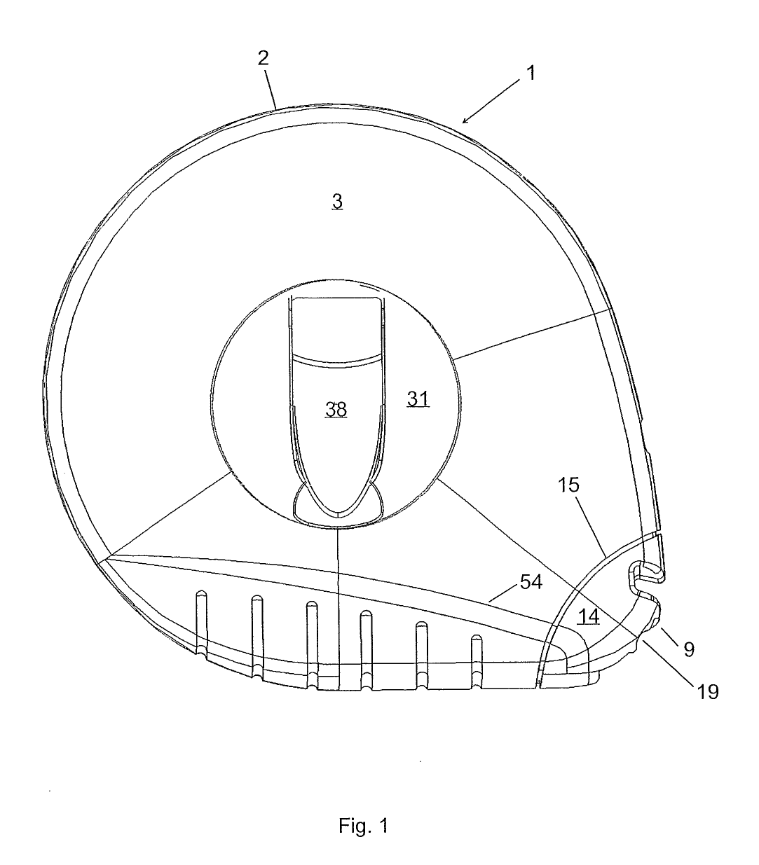

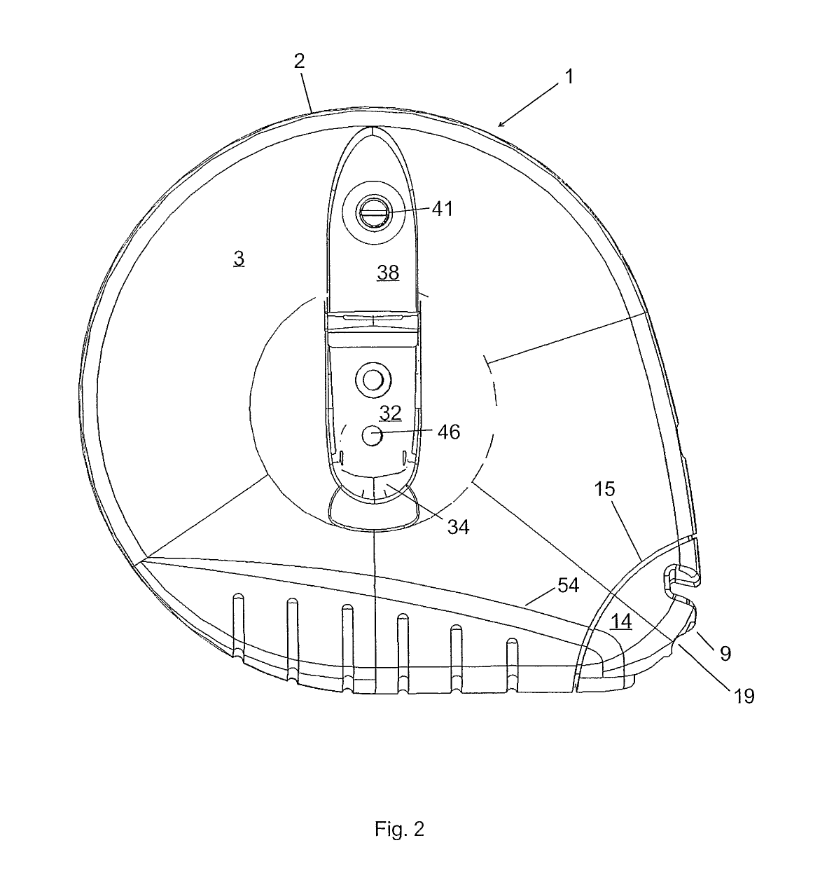

As shown in FIGS. 1 and 2, the tape measure comprises a casing 1 made from three injection moulded plastic parts. The two main parts are first and second casing halves 2, 5. Each half comprises a teardrop-shaped side wall 3, 6 which is slightly outwardly dished. The periphery of each side wall defines the circumference of a sector of a circle—approximately three-quarters, i.e. subtending approximately 270°. At each end of that sector, the periphery follows an approximately tangential path towards the point of the teardrop shape. In this embodiment, the radius of the circle is approximately 8 cm, similar to that for conventional tape measure cases. Of course other embodiments may have different sizes depending on the length and thickness of the tape measure blade.

The casing has an edge wall formed from half walls (4, 7) which runs around the periphery of respective side walls 3, 6. The two casing halves 2, 5 may be joined together by screws (not shown), or by ultrasonic welding, or by snap-fitting projections, as described in GB 2 369 103.

The tangential periphery of each casing half 2, 5 does not extend to the point 9 of the teardrop. Instead, a curved edge 15, 16 on each casing half 2, 5 meets the periphery at approximately 90°.

A one-piece moulding 14 forms the tip of the teardrop shaped casing. As can be seen, the moulding 14 is shaped to provide a smooth continuation of the casing halves 2, 5. The moulding has a skirt (not shown) joined to the exposed parts of the moulding, such that when the casing is assembled the skirt lies against inside surfaces of the casing halves 2, 5 and their edges 15, 16 fit against a step. In order to assist in holding the moulding in place, the inside faces of the casing halves 2, 5 incorporate studs which engage holes in the skirt.

The peripheral wall of the moulding 14 includes a slot 19 through which the measuring tape can be drawn out, for use.

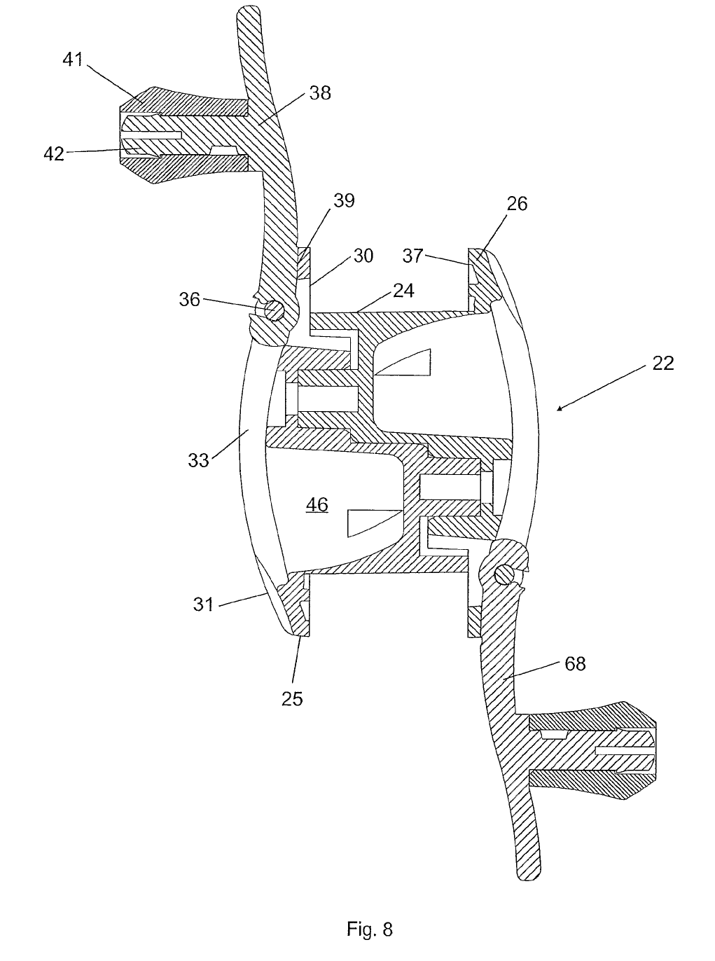

A winding drum 22, shown in cross-section in FIG. 8, fits within the casing 1. One end of the measuring tape (not shown) is attached to this drum 22, and the tape coils up around the outer surface 24 of this drum. This measuring tape may be made of material conventionally used for long tapes, such as steel or glass-reinforced fibre.

The drum 22 comprises two parts 25, 26 which screw together through holes in the casing haves 2, 5. Annular surfaces 30 and 37 abut the outer of the casing around the holes thereby retaining the drum 22 axially within the case.

One side of the drum 22 has a slightly domed surface 31. A channel 32 bounded by parallel side walls 33 runs diametrically across the domed surface 31. A lip 34 with a concave inner wall 35 closes one end of the channel. Pin 36 runs perpendicularly between the two channel side walls near, but spaced from, the opposite end of the channel 32. One end of a first winding handle 38 is hinged on this pin 36.

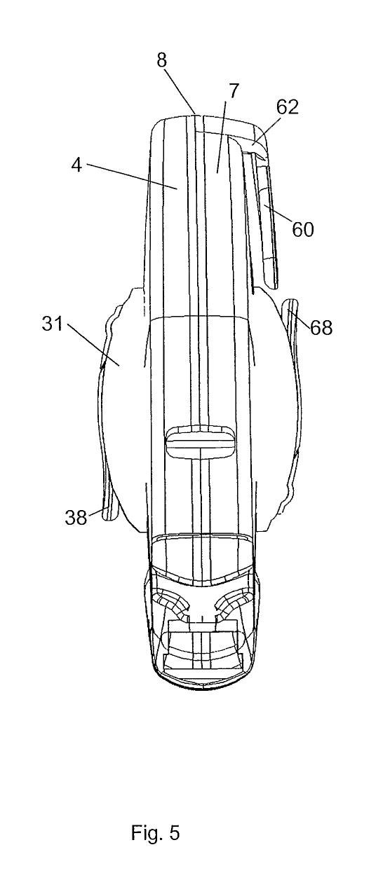

As shown in FIGS. 1 and 5 when the first winding handle is not in use it lies within the channel 32 and its upper surface is generally flush with the domes surface 31 of the drum 22. When it is required to wind in the tape, the handle 38 is turned outwards around the hinge pin 36 until its surface 40 abuts a stop surface 39 on the floor of the channel 32. This exposes a winding knob 41 rotatable on a spindle 42 projecting from the handle. When the handle 38 is not in use this spindle 42 and winding knob fit into a recess 46 in the drum 22.

The second winding handle 68 operates in exactly the same manner as the first winding handle 38.

The casing halves 2, 5 include respective zones, opposite to each other, in which the two halves are specially shaped to assist the user in gripping the casing. These zones extend radially inwardly from the edge walls 4, 7 part way towards the central regions of the faces 3, 6.

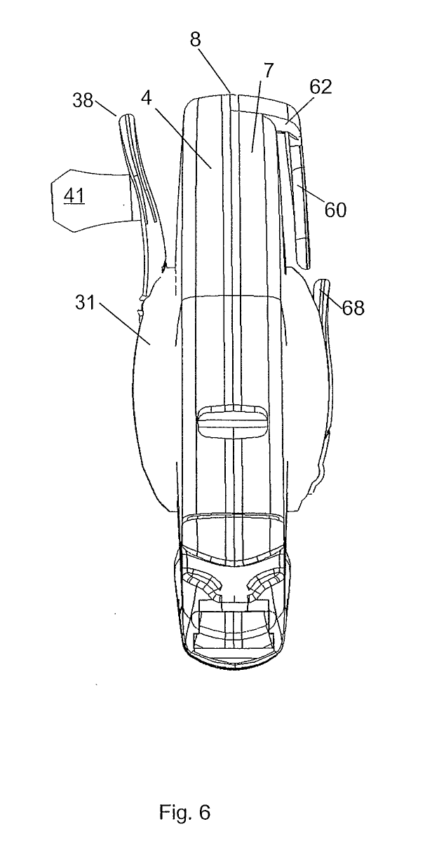

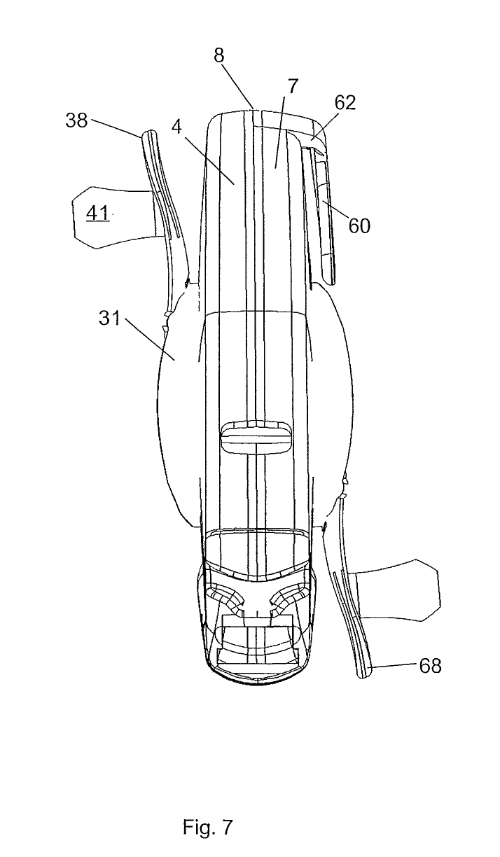

As seen in FIGS. 5, 6 and 7, these shaped zones of the casing halves 2, 5 incorporate slight axially outward bulges 53 and 55. These meet the remainder of the faces 3, 6 of the casing along curved lines 54, 56.

As shown in the figures, a belt clip is provided by a tongue 60 overlies a matching area cut out from the side wall 6. It is at an approximately uniform spacing from the level of the side wall, thus defining a slot between the tongue 60 and the side wall 6. The tongue 60 is attached to the remainder of the casing half 5 by an extension 62 from the edge wall 7.

To facilitate moulding the area of the side wall 6 directly beneath the tongue 60 is cut out. The appearance is that this area of the side wall has been displaced outwards to form the tongue 60.

The tongue can be hooked over the belt of a user. The belt then fits in the slot between the tongue 60 and the side wall 6.

1. A tape measure having a rotatably mounted winding drum or reel, a measuring tape attached to the drum so as to be coilable thereon, and a winding handle acting on each side of the drum.

2. A tape measure according to claim 1, wherein at least one winding handle is retractable.

3. A tape measure according to claim 2, wherein both winding handles are retractable.

4. (canceled)

5. The tape measure of claim 1, further comprising a casing wherein the winding drum or reel is located within the casing.

6. The tape measure of claim 5, wherein the casing is substantially tear-drop shaped.

7. The tape measure of claim 5, wherein the casing comprises first and second halves.

8. The tape measure according to claim 7, wherein the halves are joined by screws, snap-fitting projections or ultrasonic welding.

9. The tape measure according to claim 7, wherein each of the first and second halves comprise a tangential periphery formed at least in part by a curved edge that meets the periphery at approximately 90°.

10. The tape measure according to claim 1, wherein the winding drum comprises a first slightly domed surface, a first channel running diametrically across the domed surface, a first lip with a concave inner wall closing one end of the channel, a first pin running perpendicularly across the channel, wherein one end of a first winding handle is hinged on the pin, and at least a portion of the first winding handle received in the channel when not in use.

11. The tape measure according to claim 10, wherein the winding drum further comprises a second slightly domed surface, a second channel running diametrically across the second domed surface, a second lip with a concave inner wall closing one end of the second channel, a second pin running perpendicularly across the second channel, wherein one end of a second winding handle is hinged on the second pin, and at least a portion of the second winding handle received in the second channel when not in use.
